(19) United States
(12) Patent Application Publication
(10) Pub. No.: US 2025/0310151 A1
(43) Pub. Date: Oct. 2, 2025

(54) METHOD AND APPARATUS FOR DETECTING SERIAL COMMUNICATION COLLISION

(71) Applicant: Microchip Technology Incorporated, Chandler, AZ (US)

(72) Inventors: Amund Aune, Heimdal (NO); Stein Julusmoen, Trondheim (NO)

(73) Assignee: Microchip Technology Incorporated, Chandler, AZ (US)

(21) Appl. No.: 19/092,186

(22) Filed: Mar. 27, 2025

Related U.S. Application Data
(60) Provisional application No. 63/570,448, filed on Mar. 27, 2024.

(51) Int. Cl. H04L 12/413; H04L 12/40

(52) U.S. Cl. CPC H04L 12/413; H04L 12/40006

(57) ABSTRACT

A serial communication apparatus is provided. The serial communication apparatus may include a transmitter to transmit data by outputting an output signal, and a collision detection circuitry operatively coupled to the transmitter to receive the output signal. The collision detection circuitry is to receive an input signal from an input buffer, compare the input signal and output signal, and provide a collision indication signal in response to a difference between the output signal and the input signal.

### CROSS-REFERENCE TO RELATED APPLICATION

The present application claims priority to U.S. Provisional Patent Application No. 63/570,448 filed on Mar. 27, 2024, which is incorporated herein by reference in its entirety.

### TECHNICAL FIELD

The present disclosure relates generally to serial communication, and more specifically to a method and apparatus for detecting serial communication collision.

### BACKGROUND

Microcontrollers commonly integrate Universal Synchronous/Asynchronous Receiver/Transmitter (USART) peripherals for data exchange. Some microcontrollers implement collision detection in USART communication, but often restrict operation to half-duplex mode (transmit or receive only). Methods of the collision detection rely on dedicated receiver circuits, increasing complexity and power consumption. Therefore, there is a need for an improved method and apparatus for detecting serial communication collision.

### SUMMARY

According to an aspect of one or more examples, there is provided a serial communication apparatus. The serial communication apparatus may include a transmitter to transmit data and a collision detection circuitry operatively coupled to the transmitter. The collision detection circuitry may provide a collision indication in response to a difference between an output signal from the transmitter and an input signal received by an input buffer.

The output signal of the transmitter may be operatively coupled to a transmit pad through an output buffer. The input buffer may be associated with the transmit pad. The input signal may be received through the input buffer operatively coupled to a port peripheral register. The port peripheral register may access the input signal through the input buffer. The transmitter may include a transmit data buffer to store the data and a transmit shift register operatively coupled to the transmit data buffer. The transmit shift register may shift the data one bit at a time to provide the output signal for the transmit pad through the output buffer. The collision detection circuitry may compare the output signal from the transmitter with the input signal received by the input buffer associated with the transmit pad. The collision detection circuitry may be operable in a full-duplex mode.

According to an aspect of one or more examples, there is provided a method of detecting a collision in a serial communication apparatus. The method may include receiving an output signal from a transmitter of the serial communication apparatus, obtaining an input signal from an input buffer associated with a transmit pad and asserting a collision indication in response to a difference between the output signal from the transmitter and the input signal received by the input buffer.

The output signal of the transmitter may be operatively coupled to the transmit pad through an output buffer. The input signal may be operatively coupled to a port peripheral register. The port peripheral register may access the input signal through the input buffer. The transmitter may include a transmit data buffer to store a data and a transmit shift register operatively coupled to the transmit buffer data. The transmit shift register may shift the data one bit at a time to provide the output signal for the transmit pad through the output buffer. The method may include comparing the output signal from the transmitter with the input signal received by the input buffer associated with the transmit pad. The method may include triggering the comparison of the output signal and the input signal upon initiation of data transmission. The method may be operable in a full-duplex mode.

According to an aspect of one or more examples, there is provided a computing system that may include a processor and a memory storing instructions executable by the processor. The execution may cause the processor for receiving an output signal from a transmitter of a serial communication apparatus, obtaining an input signal from an input buffer associated with a transmit pad and asserting a collision indication in response to a difference between the output signal form the transmitter and the input signal received by the input buffer.

### BRIEF DESCRIPTION OF DRAWINGS

FIG. 1 shows a block diagram illustrating a serial communication apparatus according to one or more examples.

FIG. 2 shows a timing diagram of a collision detection according to one or more examples.

FIG. 3 shows a block diagram illustrating a method of detecting a collision in a serial communication apparatus according to one or more examples.

FIG. 4 shows a block diagram illustrating a computing system according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

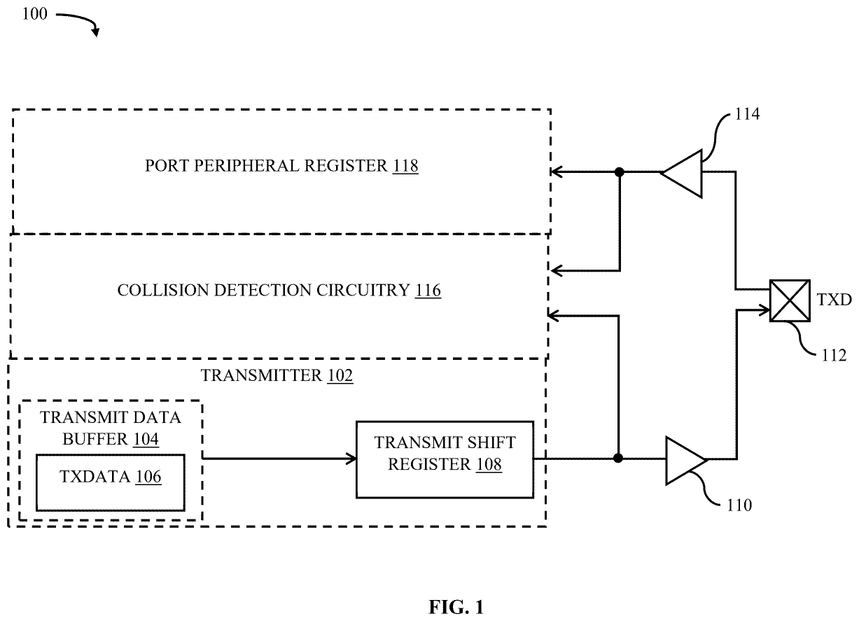

FIG. 1 shows a block diagram illustrating a serial communication apparatus 100 according to one or more examples. The serial communication apparatus 100 may leverage a combination of hardware components and control logic, to detect a collision in a serial communication interface. The serial communication apparatus 100 may include two functional blocks: a transmitter 102 and a collision detection circuitry 116. In one or more examples, the serial communication apparatus 100 may include a port peripheral register 118 to reflect an input signal. In one or more examples, the serial communication apparatus 100 may not include the port peripheral register 118, and the collision detection circuitry 116 may directly obtain the input signal. The transmitter 102 may be configured to handle serial transmission of data sent from the serial communication apparatus 100.

The transmitter 102 may receive data 106 (TX data 106) that is conveyed to a transmitter input in a parallel form and to provide an output signal at a transmitter output in a serial form one bit at a time. The output signal may correspond to a transmitted data frame. The transmitter 102 may include a transmit data buffer 104 to store the data 106 received at the transmitter input and a transmit shift register 108 to convert the data 106 from the parallel form to the serial form. The transmit shift register 108 may be operatively coupled to the transmit data buffer 104 to shift the output signal one bit at a time to the transmitter output. The serial communication apparatus 100 may include an output buffer 110 which is operatively coupled to the transmitter output and a transmit pad 112 (TXD 112) to receive the output signal. The transmit pad 112 (TXD) may serve as an output path for the output signal. The transmit pad 112 (TXD) may transmit the output signal in a bitwise manner, one bit at a time. The output signal of the transmitter 102 is operatively coupled to the transmit pad 112 through the output buffer 110.

The serial communication apparatus 100 may include an input buffer 114 associated with the transmit pad 112 to handle the input signal received through the transmit pad 112. The input buffer 114 may be operatively coupled to the port peripheral register 118. The port peripheral register 118 may access the input signal through the input buffer 114, which may be used to detect the collision in the serial communication interface. In one or more examples, the port peripheral register 118 may control configuration of the transmit pad 112 (TXD 112). The configuration may determine if the transmit pad 112 functions as an input, an output, or a combination of both. The port peripheral register 118 may provide a read-modify-write functionality for the transmit pad 112 (TXD 112) for safely configuring the transmit pad 112 as an input for detecting the collision without affecting a primary output functionality of the transmit pad 112.

The collision detection circuitry 116 may receive the output signal from the transmitter 102 of the serial communication apparatus 100. The collision detection circuitry 116 may obtain the input signal from the input buffer 114 associated with the transmit pad 112. The collision detection circuitry 116 may trigger a comparison of the output signal and the input signal upon initiation of data transmission. The collision detection circuitry 116 may compare the output signal from the transmitter 102 with the input signal received by the input buffer 114 associated with the transmit pad 112. The collision detection circuitry 116 may employ a comparator to perform bit-by-bit comparison between the input signal and the output signal.

The collision detection circuitry 116 may assert a collision indication in response to a difference between the output signal from the transmitter 102 and the input signal received by the input buffer 114. The difference between the output signal and the input signal may indicate the collision in the serial communication interface. The difference between the output signal and the input signal may arise when another device attempts to transmit data simultaneously on the same serial communication interface. The collision indication may serve as an alert to the control logic of the serial communication apparatus 100 informing about the collision. The collision detection circuitry 116 may allow the serial communication apparatus 100 to operate in a full-duplex mode.

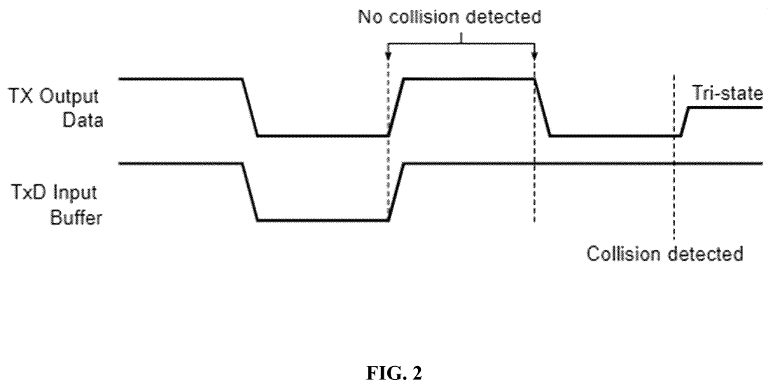

FIG. 2 shows a timing diagram of a collision detection in data transmission by the serial communication apparatus 100 of FIG. 1 according to one or more examples. Time units may be defined by vertical dashed lines, and each time unit may correspond substantially to a clock cycle. The timing diagram of FIG. 2 shows two signals: the output signal at the transmit shift register 108 (TX output data signal) and the input signal received from the input buffer 114 (TxD input buffer signal). At a first time unit and a second time unit, the TX output data signal and the TxD input buffer signal are identical, suggesting no collision is detected during these clock cycles. At a third time unit, the TX output data signal and the TxD input buffer signal are different, indicating a collision. The collision detection circuitry 116 may assert the collision indication at the third time unit after which the transmit enable signal is set to a logic low, leading to the transmit buffer 110 turning off and consequently the TX output data signal being tri-stated.

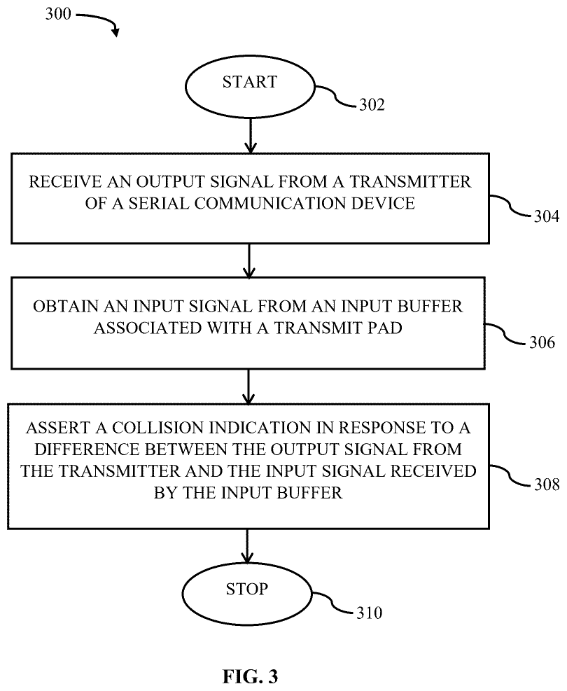

FIG. 3 shows a flowchart 300 illustrating a method of detecting a collision in the serial communication apparatus 100 according to one or more examples. It may be noted that in order to explain the method operations of the flowchart 300, references will be made to the elements explained in FIG. 1.

The flowchart 300 starts at operation 302. At operation 304, the method may include receiving the output signal from the transmitter 102 of the serial communication apparatus 100. At operation 306, the method may include obtaining the input signal from the input buffer 114 associated with the transmit pad 112. At operation 308, the method may include asserting the collision detection in response to a difference between the output signal from the transmitter 102 and the input signal received by the input buffer 114.

The flowchart 300 terminates at operation 310. It may be noted that the flowchart 300 is explained to have above stated process operations; however, those skilled in the art would appreciate that the flowchart 300 may have more/less number of process operations which may enable all the above stated examples of the present disclosure.

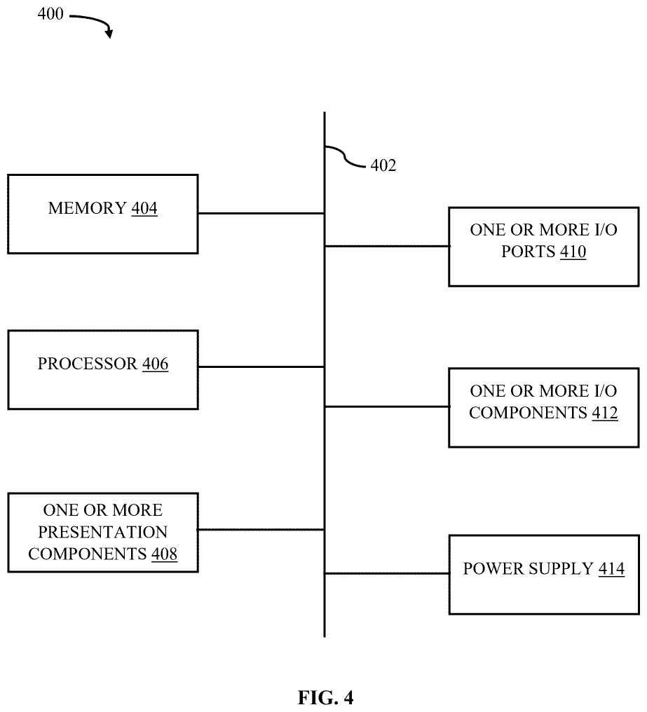

FIG. 4 shows a block diagram illustrating a computing system 400 according to one or more examples that may perform one or more of the processes described above. The computing system 400 may include a memory 404, a processor 406, one or more presentation component(s) 408, one or more I/O port(s) 410, one or more I/O component(s) 412, and a power supply 414, which may be communicatively coupled by way of a bus 402. While the computing system 400 is shown in FIG. 4, the components illustrated in FIG. 4 are not intended to be limiting. Additional or alternative components may be used in various examples. Furthermore, in certain examples, the computing system 400 includes fewer components than those shown in FIG. 4. Components of the computing system 400 shown in FIG. 4 will now be described in additional detail.

The processor 406 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. It is noted that a general-purpose processor may be a microprocessor, but in the alternative, the processor 406 may include any processor, controller, microcontroller, or state machine.

In one or more examples, the processor 406 may include hardware for executing instructions (e.g., software code, firmware code, hardware description), such as those making up a computer program. As an example, and not by way of limitation, to execute instructions, the processor(s) 406 may retrieve (or fetch) the instructions from an internal register, an internal cache, the memory 404, the I/O component(s) 412 or a storage device and decode and execute them. The instructions may be configured to adapt the processor 406 to perform at least a portion or a totality of the operations discussed for the serial communication apparatus 100, the transmitter 102, the collision detection circuitry 116, and the port peripheral register 118 of FIG. 1.

The computing system 400 may include the memory 404, which is coupled to the processor(s) 406. The memory 404 may be used for storing data, metadata, and programs for execution by the processor(s) 406. The memory 404 may include one or more of volatile and non-volatile memories, such as Random-Access Memory (“RAM”), Read-Only Memory (“ROM”), a solid-state disk (“SSD”), Erasable Programmable Read-only memory (EPROM), Hard Disk Drive (“HDD”), Flash memory, Phase Change Memory (“PCM”), or other types of data storage. The memory 404 may be internal or distributed memory.

The computing system 400 may include the one or more presentation component(s) 408 that may present data indications to a user or other device. The one or more presentation component(s) 408 may include a display device, speaker, printing component, vibrating component, and the like. The one or more I/O ports 410 may allow the computing system 400 to be logically coupled to other devices including the one or more I/O components 412, some of which may be built in.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A serial communication apparatus, comprising:
a transmitter to transmit data by outputting an output signal; and
a collision detection circuitry operatively coupled to the transmitter to receive the output signal;
wherein the collision detection circuitry is to receive an input signal from an input buffer, compare the input signal and output signal, and provide a collision indication signal in response to a difference between the output signal and the input signal.

2. The serial communication apparatus of claim 1, wherein the output signal of the transmitter is operatively coupled to a transmit pad through an output buffer.

3. The serial communication apparatus of claim 1, comprising a port peripheral register to receive the input signal;
wherein the input buffer is associated with a transmit pad and the input signal is received through the input buffer operatively coupled to the port peripheral register.

4. The serial communication apparatus of claim 3, wherein the port peripheral register is to access the input signal through the input buffer.

5. The serial communication apparatus of claim 1, wherein the transmitter comprises:
a transmit data buffer to store the data; and
a transmit shift register operatively coupled to the transmit data buffer to shift the data one bit at a time to provide the output signal for a transmit pad through an output buffer.

6. The serial communication apparatus of claim 1, wherein the collision detection circuitry is operable in a full-duplex mode.

7. A method of detecting a collision in a serial communication apparatus, the method comprising:
receiving an output signal from a transmitter of the serial communication apparatus;
obtaining an input signal from an input buffer associated with a transmit pad;
comparing the input signal and the output signal; and
asserting a collision indication signal in response to a difference between the output signal from the transmitter and the input signal received by the input buffer.

8. The method of claim 7, wherein the output signal of the transmitter is operatively coupled to the transmit pad through an output buffer.

9. The method of claim 7, wherein the input signal is operatively coupled to a port peripheral register.

10. The method of claim 9, wherein the port peripheral register is to access the input signal through the input buffer.

11. The method of claim 7, wherein the transmitter comprises:
a transmit data buffer to store data; and
a transmit shift register operatively coupled to the transmit data buffer, the transmit shift register is to shift the data one bit at a time to provide the output signal for the transmit pad through an output buffer.

12. The method of claim 11, further comprising triggering the comparison of the output signal and the input signal upon initiation of data transmission.

13. The method of claim 7, wherein the method is operable in a full-duplex mode.

14. A computing system, comprising:
a processor; and
a memory storing instructions executable by the processor, wherein the instructions, when executed, cause the processor to:
receive an output signal from a transmitter of a serial communication apparatus;
obtain an input signal from an input buffer associated with a transmit pad; and
assert a collision indication signal in response to a difference between the output signal from the transmitter and the input signal received by the input buffer.

15. The computing system of claim 14, wherein the output signal of the transmitter is operatively coupled to the transmit pad through an output buffer.

16. The computing system of claim 14, wherein the input signal is operatively coupled to a port peripheral register.

17. The computing system of claim 16, wherein the port peripheral register is to access the input signal through the input buffer.

18. The computing system of claim 14, wherein the transmitter comprises:
a transmit data buffer to store data; and
a transmit shift register operatively coupled to the transmit data buffer, the transmit shift register is to shift the data one bit at a time to provide the output signal for the transmit pad through an output buffer.

19. The computing system of claim 14, wherein the computing system is operatable in a full-duplex mode.
